(19) United States
(12) Patent Application Publication
(10) Pub. No.: US 2025/0163302 A1
(43) Pub. Date: May 22, 2025

(54) Window Film

(71) Applicant: LINTEC Corporation, Tokyo (JP)

(72) Inventors: Hiroki Minematsu, Tokyo (JP); Miki Kamo, Tokyo (JP); Masato Naitou, Tokyo (JP)

(21) Appl. No.: 18/842,982

(22) PCT Filed: Dec. 13, 2022
(86) PCT No.: PCT/JP2022/045852

§ 371 Date: Jan. 13, 2025

(30) Foreign Application Priority Data
Mar. 3, 2022 (JP) 2022-032823

(51) Int. Cl. C09J 11/04; C09J 7/29; C09J 7/38; C09J 9/00; C09J 133/08

(52) U.S. Cl. CPC C09J 11/04; C09J 7/29; C09J 7/385; C09J 9/00; C09J 133/08; C09J 2301/122; C09J 2433/00; C09J 2467/006

(57) ABSTRACT

A window film includes a substrate and an adhesive agent layer disposed on one main surface of the substrate, in which the creep compliance of the adhesive agent layer after 1200 seconds of continuous application of a shear stress of 3000 Pa at 23° C. is 200 (1/MPa) or less.

### TECHNICAL FIELD

The present invention relates to window film.

### BACKGROUND ART

Window films are adhesive films that are attached to windows to impart a shatterproof function, a function of shielding ultraviolet and infrared rays of the sun, the security performance, and the like to the windows of moving objects such as motor vehicles, buildings, and the like, and are widely utilized.

As a method for installing window films, generally the so-called water pasting method is adopted. For example, as disclosed in Patent Document 1, the water pasting method is a method in which water or water containing a surfactant is sprayed onto the surface of a window to which a window film is to be attached, and then air, moisture, and the like between the window film and the surface of the window are pushed out by pressing force of a squeegee such as a spatula to attach the window film to the surface of the window.

### CITATION LIST

### Patent Document

Patent Document 1: JP 2015-229303 A

### SUMMARY OF THE INVENTION

### Problem to be Solved by the Invention

In a case of adopting the water pasting method, when a window film is attached to the surface of a window, the film is temporarily fixed at a predetermined position via water or the like (is positioned) and then the film is shifted to finely adjust the attachment position of the film for installation.

This fine adjustment is performed by gradually shifting the film to the desired position while applying proper force to the film using a squeegee such as a spatula or by hand. In such an attachment method by hand, linear or planar local stress caused by the squeegee or point or planar local stress caused by the fingertips or back of the worker's hand is likely to be applied to the film surface in the vertical direction, the shear direction, or both the vertical direction and the shear direction. Since such stress is likely to affect the adhesive agent of window films, the stress may cause the adhesive agent to be deformed and cloudy, and this may manifest as glue slippage such as cloudiness after attachment of the window film.

In particular, window glass of motor vehicles, such as the front windshield and rear windshield, often has a curved surface shape, and fine adjustment of the attachment position of the film is frequently performed when a window film is attached to such glass surfaces. In such a case, it is often greatly difficult for the worker to align the attachment position, and the amount of force applied by the worker changes slightly each time the worker makes the fine adjustment of the attachment position. For this reason, more stress than necessary is often applied to the adhesive agent of the window film, and as a result, the glue slippage described above is likely to occur. In addition, since the size of hands and the amount of force applied vary depending on the worker, it is also difficult to prevent the glue slippage mentioned above.

In addition, window glass of buildings and the like is often flat glass that is installed perpendicular to the ground, but is not limited to flat glass and may be glass having a curved surface. Particularly, in the case of glass having a curved surface as well, it is greatly difficult for the worker to align the attachment position, fine adjustment of the attachment position may be frequently performed, and there is a case where glue slippage is likely to occur as in the case of the glass of motor vehicles described above.

The present invention has been made in view of the above circumstances, and an object thereof is to provide a window film including an adhesive agent layer with suppressed glue slippage due to the deformation of adhesive agent.

### Means for Solving Problem

The aspects of the present invention are as follows.

[1] A window film comprising a substrate and an adhesive agent layer disposed on one main surface of the substrate, wherein a creep compliance of the adhesive agent layer after 1200 seconds of continuous application of a shear stress of 3000 Pa at 23° C. is 200 (1/MPa) or less.

[2] The window film according to [1], wherein the window film has infrared absorbing property.

[3] The window film according to [2], wherein the adhesive agent layer contains an infrared absorbing agent.

[4] The window film according to any one of [1] to [3], wherein the adhesive agent layer contains an ultraviolet absorbing agent.

[5] The window film according to any one of [1] to [4], comprising a hard coat layer disposed on the other main surface of the substrate.

[6] The window film according to [5], wherein the window film has infrared absorbing property and the hard coat layer contains an infrared absorbing agent.

[7] The window film according to [5] or [6], wherein the hard coat layer contains a coloring agent.

### Effect of the Invention

According to the present invention, it is possible to provide a window film including an adhesive agent layer with suppressed glue slippage due to the deformation of adhesive agent.

### BRIEF DESCRIPTION OF DRAWINGS

FIG. 1A is a schematic cross-sectional view illustrating an example of a window film according to the present embodiment; and

FIG. 1B is a schematic cross-sectional view illustrating another example of a window film according to the present embodiment.

### MODE(S) FOR CARRYING OUT THE INVENTION

Hereinafter, the present invention will be described in detail based on specific embodiments.

### (1. Window Film)

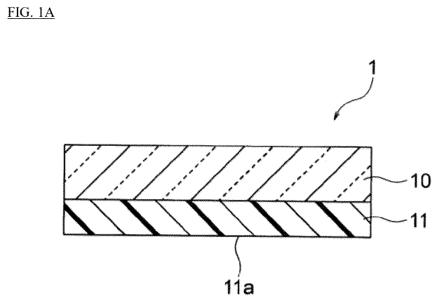

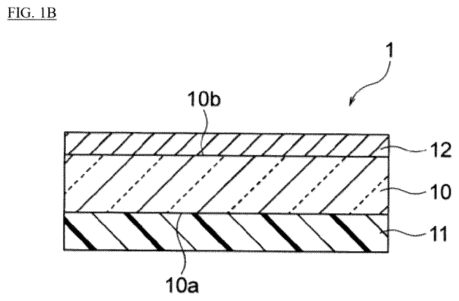

As illustrated in FIG. 1A, window film 1 according to the present embodiment includes a substrate 10 and an adhesive agent layer 11. In addition, the window film may include other constituents as long as the effects of the present invention are obtained. In other words, the window film may include layers other than the substrate and the adhesive agent layer. For example, a release sheet may be disposed on a main surface 11a of the adhesive agent layer 11 in order to protect the adhesive agent layer 11 until the adhesive agent layer 11 is attached to an adherend.

When the window film 1 is used, the exposed main surface 11a of the adhesive agent layer 11 is attached to an adherend (mainly the window of a motor vehicle or building), and the window film exerts the predetermined functions.

As described above, window films are usually installed by a water pasting method, and at that time, stress is likely to be applied to the film in the vertical direction, the shear direction, or both the vertical direction and the shear direction by fine adjustment of the attachment position. At this time, the adhesive agent layer adheres to the surface of the window via water or a liquid containing a surfactant, and therefore is not firmly stuck to the surface of the window. Therefore, fine adjustment of the attachment position is possible by the application of stress to the film, but the adhesive agent itself may be deformed by the application of stress to the film in a case where the adhesive agent constituting the adhesive agent layer is relatively soft. When such deformation of the adhesive agent is large, the deformation may manifest as glue slippage such as cloudiness after attachment, and this may become a problem in appearance.

Hence, in the present embodiment, the glue slippage is suppressed by controlling the physical properties of the adhesive agent layer as follows. Hereinafter, the constituents of the window film are described in detail.

### (1.1. Substrate)

The substrate according to the present embodiment is a material that imparts rigidity to the window film, and has a function of supporting the adhesive agent layer. The material for the substrate is not particularly limited as long as it has the functions. In the present embodiment, it is preferable to use a resin material.

Examples of the resin material include films formed of polyester-based resins such as polyethylene terephthalate and polyethylene naphthalate; polyolefin-based resins such as polyethylene, polypropylene, poly-4-methylpentene-1, and polybutene-1; polyurethane-based resins; polycarbonate-based resins; polyvinyl chloride-based resins; polyethersulfone-based resins; polyethylene sulfide-based resins; styrene-based resins; acrylic resins; polyamide-based resins; and cellulose-based resins such as cellulose acetate, or laminated films thereof.

Among these, films formed of polyolefin-based resins and polyester-based resins, which are excellent in mechanical strength and economical efficiency, or laminated films thereof are preferred, films formed of polyester-based resins or laminated films thereof are particularly preferred from the viewpoint of easily obtaining a window film that satisfies the optical properties described later, and a polyethylene terephthalate film or a laminated film including polyethylene terephthalate is preferred among these.

The laminated film is preferably a film in which one kind or two or more kinds of resin materials are laminated in a plurality of layers, and such laminated films also include laminated films, which exhibit wavelength selectivity and have a multilayer structure having at least two or more nanoscale layers, and the like. Incidentally, a laminated film not exhibiting wavelength selectivity or a laminated film exhibiting wavelength selectivity can be appropriately selected and suitably used as long as a window film that satisfies the optical properties described later can be obtained. The term “wavelength selectivity” used here refers to the property of absorbing or reflecting a specific wavelength region, and a laminated film exhibiting wavelength selectivity means a laminated film capable of controlling the transmittance in a specific wavelength region.

One surface or both surfaces of the substrate may be subjected to a surface treatment by an oxidation method, a roughening method, or the like for the purpose of improving close contact properties to a layer provided on the substrate. Examples of the oxidation method include corona discharge treatment, chromic acid treatment (wet type), flame treatment, hot air treatment, and ozone/ultraviolet irradiation treatment. In addition, examples of the roughening method include a sandblasting method and a solvent treatment method.

The thickness of the substrate is not particularly limited as long as predetermined rigidity is exhibited, and may be appropriately set depending on the intended use. In the present embodiment, the thickness of the substrate is preferably 5 to 200 μm, more preferably 10 to 100 μm from the viewpoint of securing mechanical strength suitable for workability during installation. Moreover, the thickness of the substrate is preferably 15 to 50 μm, particularly preferably 20 to 40 μm from the viewpoint of mainly taking a design in which the optical properties described later are adjusted by layers other than the substrate and the viewpoint of obtaining a thin window film. In addition, the thickness of the substrate is preferably 30 to 90 μm, particularly preferably 40 to 80 μm from the viewpoint of including a design in which the optical properties described later are adjusted in the substrate.

The substrate may be transparent or colored. In addition, a metal such as aluminum, gold, silver, copper, nickel, cobalt, chromium, tin, or indium may be vapor-deposited on the substrate.

### (1.2. Adhesive Agent Layer)

The adhesive agent layer according to the present embodiment is mainly attached to the surface of a window of a motor vehicle or building to fix the window film to the surface of the window and allow the window film to exert the predetermined functions. The window to which the adhesive agent layer according to the present embodiment is attached may be composed of a glass material, or may be composed of a glass substitute material such as plastic. In addition, the surface of the window to which the adhesive agent layer according to the present embodiment is attached may be the surface of a window on the side where direct sunlight enters, or the surface of the window on the opposite side. In other words, in the case of a motor vehicle, the surface of the window may be either the surface of the window outside the vehicle or the surface of the window inside the vehicle. In the case of a building, the surface of the window may be either the surface of the window on the outdoor side or the surface of the window on the indoor side. The adhesive agent layer 11 is formed of an adhesive agent described later.

The adhesive agent layer may be composed of one layer (single layer), or may be composed of a plurality of layers of two or more layers. In a case where the adhesive agent layer has a plurality of layers, the plurality of layers may be the same as or different from each other, and the combination of layers constituting the plurality of layers is not particularly limited.

The thickness of the adhesive agent layer 11 is preferably 1 to 100 μm, more preferably 3 to 80 μm, still more preferably 5 to 60 μm, particularly preferably 6 to 40 μm, and among these, is preferably 7 to 30 μm, most preferably 8 to 25 μm. This allows the adhesive agent layer 11 to be likely to exert suitable adhesiveness and less likely to undergo glue slippage.

### (1.2.1. Physical Properties of Adhesive Agent)

In the present embodiment, as the adhesive agent has the following physical properties, glue slippage due to deformation of the adhesive agent can be suppressed.

### (1.2.2. Creep Compliance of Adhesive Agent)

In the present embodiment, the creep compliance of the adhesive agent after 1200 seconds (after 20 minutes) of continuous application of a shear stress of 3000 Pa at 23° C. is preferably 200 (1/MPa) or less. The creep compliance indicates the amount of strain per unit stress in a case where a constant stress is applied.

By controlling the creep compliance within the above range, the adhesive agent layer is less likely to be deformed when stress is applied to the adhesive agent layer by pulling of the film or by a squeegee such as a spatula during installation of the window film as well. As a result, the glue slippage can be effectively suppressed.

From the above viewpoints, the creep compliance of the adhesive agent is preferably 150 (1/MPa) or less, more preferably 100 (1/MPa) or less, still more preferably 80 (1/MPa) or less, particularly preferably 66 (1/MPa) or less. The creep compliance of the adhesive agent can be adjusted, for example, by changing the composition, crosslinked structure, and viscoelasticity of the adhesive agent and the weight average molecular weight and glass transition temperature of the main polymer constituting the adhesive agent. Incidentally, the lower limit of the creep compliance of the adhesive agent is usually 0 (1/MPa) or more, and is preferably 1 (1/MPa) or more, more preferably 8 (1/MPa) or more, still more preferably 15 (1/MPa) or more, particularly preferably 20 (1/MPa) or more from the viewpoint that the storage modulus, adhesive force and the like of the adhesive agent can be easily adjusted to desired ranges.

The creep compliance may be measured by a known method. For example, the adhesive agent layer is prepared into a sample having a predetermined size, a predetermined stress is applied to the sample using a dynamic viscoelasticity measuring instrument, and the strain of the sample is measured until a predetermined time elapses. The creep compliance under the above conditions can be calculated from the measured strain and applied stress.

### (1.2.3. Storage Modulus)

In the present embodiment, the storage modulus (G′) of the adhesive agent at 23° C. and a frequency of 1 Hz is preferably more than 0.06 MPa. The storage modulus is one of the indicators of the ease of deformation (hardness) of the adhesive agent layer. By controlling the storage modulus of the adhesive agent at 23° C. within the above range, it becomes easier to keep the creep compliance described above within a predetermined range, and glue slippage can be further suppressed. In addition, the workability of position adjustment of the film in the water pasting method is likely to be suitable.

The storage modulus at 23° C. is more preferably 0.07 to 1 MPa, still more preferably 0.08 to 0.6 MPa, preferably 0.09 to 0.3 MPa. This makes it easier to keep the creep compliance within a predetermined range, and glue slippage can be further suppressed. In addition, since the desired adhesive force is likely to be exerted, the adhesive agent is favorably fixed to the adherend after installation as well, and also excellent impact resistance and shatterproof properties are exerted.

The storage modulus (G′) of the adhesive agent at 40° C. and a frequency of 1 Hz is preferably 0.01 to 1 MPa, more preferably 0.03 to 0.6 MPa, still more preferably 0.04 to 0.3 MPa, preferably 0.05 to 0.15 MPa. This makes it easier to keep the creep compliance within a predetermined range, and glue slippage can be further suppressed. In addition, since the desired adhesive force is likely to be exerted in high temperature environments such as summer as well, the adhesive agent is likely to be favorably fixed to the adherend after installation as well.

The storage modulus (G′) of the adhesive agent at 80° C. and a frequency of 1 Hz is preferably 0.001 to 0.5 MPa, more preferably 0.01 to 0.2 MPa, still more preferably 0.02 to 0.1 MPa, preferably 0.03 to 0.08 MPa, preferably 0.04 to 0.07 MPa. This makes it easier to decrease the creep compliance described above, and glue slippage can be further suppressed. In addition, since the desired adhesive force is likely to be exerted in high temperature environments such as summer as well, the adhesive agent is likely to be favorably fixed to the adherend after installation as well.

The storage modulus of the adhesive agent can be adjusted, for example, by changing the composition, crosslinked structure, and viscoelasticity of the adhesive agent and the weight average molecular weight and glass transition temperature of the main polymer constituting the adhesive agent.

The storage modulus (G′) may be measured by a known method. For example, the adhesive agent layer is prepared into a sample having a predetermined size, and strain is applied to the sample at a predetermined frequency in a predetermined temperature range using a dynamic viscoelasticity measuring instrument to measure the modulus. The storage modulus under the above conditions can be calculated from the measured modulus.

### (1.2.4. Loss Tangent)

In the present embodiment, the loss tangent (tan δ) of the adhesive agent at 23° C. and a frequency of 1 Hz is preferably 1 or less. The loss tangent is defined as “loss modulus/storage modulus” and is a value measured by the response to the stress applied to an object using a dynamic viscoelasticity measuring instrument. By controlling the loss tangent of the adhesive agent at 23° C. within the above range, it becomes easier to keep the creep compliance described above within a predetermined range, and glue slippage can be further suppressed. In addition, since the workability of position adjustment of the film and the like in water pasting is likely to be suitable and the adhesive force described later is likely to be exerted, the adhesive agent is likely to be favorably fixed to the adherend after installation as well.

The loss tangent at 23° C. is more preferably 0.9 or less, and is still more preferably 0.8 or less, particularly preferably 0.6 or less in the case of an adhesive agent having a relatively low storage modulus at 23° C., and among these, is preferably 0.5 or less. Meanwhile, the lower limit of the loss tangent at 23° C. is not particularly limited, but is preferably 0.01 or more, more preferably 0.1 or more, and still more preferably 0.2 or more from the viewpoint of the flexibility and adhesiveness of the adhesive agent. Incidentally, the lower limit of the loss tangent at 23° C. is still more preferably 0.5 or more, particularly preferably 0.8 or more in the case of an adhesive agent having a relatively high storage modulus at 23° C.

The loss tangent of the adhesive agent can be adjusted, for example, by changing the composition, crosslinked structure, and viscoelasticity of the adhesive agent and the weight average molecular weight, glass transition temperature, and the like of the main polymer constituting the adhesive agent.

The loss tangent may be measured by a known method. For example, the adhesive agent layer is prepared into a sample having a predetermined size, and strain is applied to the sample at a predetermined frequency in a predetermined temperature range using a dynamic viscoelasticity measuring instrument to measure the loss modulus and storage modulus, and the loss tangent at 23° C. can be calculated from the measured moduluses.

### (1.2.5. Gel Fraction and Sol Fraction of Adhesive Agent)

The gel fraction of the adhesive agent according to the present embodiment is preferably 30% to 100%. This makes it easier to satisfy the creep compliance described above, and glue slippage can be effectively suppressed. In addition, the viscoelasticity described above is likely to be satisfied, and the workability of position adjustment of the film and the like in water pasting is likely to be suitable, as well as the adhesive force described later is likely to be exerted and the adhesive agent is likely to be favorably fixed to the adherend after installation.

The gel fraction of the adhesive agent according to the present embodiment is more preferably 40% to 90%, still more preferably 50% to 85%, particularly preferably 60% to 80%. The gel fraction of the adhesive agent may be measured by the method presented in Test Examples described later.

In addition, in the present embodiment, the sol fraction of the adhesive agent is calculated as (100−gel fraction) %. The gel fraction is the above-described gel fraction.

The sol fraction of the adhesive agent according to the present embodiment is preferably 0% to 70%, more preferably 10% to 60%, still more preferably 15% to 50%, particularly preferably 20% to 40%. This makes it easier to satisfy the creep compliance described above, and glue slippage can be effectively suppressed. In addition, the viscoelasticity described above is likely to be satisfied, and the workability of position adjustment of the film and the like in water pasting is likely to be suitable, as well as the adhesive force described later is likely to be exerted and the adhesive agent is likely to be favorably fixed to the adherend after installation as well.

### (1.2.6. Pressure Sensitive Adhesive Force of Adhesive Agent Layer)

In the present embodiment, the adhesive force when the adhesive agent layer is peeled off at a peel angle of 180° and a peel speed of 0.3 m/min is preferably 1 N/25 mm or more. This improves adhesion to the adherend (the surface of a window, or the like) and allows the window film to be stably fixed to the adherend (the surface of a window, or the like). In particular, when the adhesive agent has the adhesive force described above while satisfying the creep compliance described above, the adhesive agent is likely to be favorably fixed to the adherend after installation by water pasting.

The adhesive force is preferably 2 to 100 N/25 mm, more preferably 3 to 60 N/25 mm, still more preferably 4 to 30 N/25 mm, particularly preferably 5 to 22 N/25 mm, and is preferably 8 to 18 N/25 mm from the viewpoint of suppressing the occurrence of glue slippage. Specific measurement conditions of the adhesive force will be described later in Examples.

### (1.3. Composition of Adhesive Agent)

The composition of the adhesive agent according to the present embodiment is not particularly limited as long as the adhesive agent has the physical properties described above. For example, the adhesive agent may be any of an acrylic adhesive agent, a polyester-based adhesive agent, a polyurethane-based adhesive agent, a rubber-based adhesive agent, a silicone-based adhesive agent, or the like. In addition, the adhesive agent may be of any of an emulsion type, a solvent type, or a solventless type. Furthermore, the adhesive agent may have or may not have a crosslinked structure.

With regard to the adhesive agent according to the present embodiment, the adhesive agent is preferably an acrylic adhesive agent, more preferably an acrylic adhesive agent having a crosslinked structure from the viewpoint of ease of realizing the physical properties described above and the viewpoints of adhesive properties, optical properties, and the like.

Specifically, the adhesive agent is preferably an adhesive agent obtained from an adhesive composition containing a (meth)acrylic acid ester polymer (A) (hereinafter, referred to as “adhesive composition P” in some cases), and is preferably an adhesive agent obtained by crosslinking an adhesive composition containing a (meth)acrylic acid ester polymer (A) and a crosslinking agent (B), that is, an adhesive agent containing a crosslinked product of a (meth)acrylic acid ester polymer (A) and a crosslinking agent (B). When the adhesive agent is such an adhesive agent, physical properties described above are likely to be satisfied and favorable adhesive force is likely to be obtained. Incidentally, in the present specification, (meth)acrylic acid means both acrylic acid and methacrylic acid. The same applies to other similar terms. In addition, the term “polymer” also includes the concept of a “copolymer.”

### (1.3.1. (Meth)Acrylic Acid Ester Polymer (A))

The (meth)acrylic acid ester polymer (A) preferably contains a (meth)acrylic acid alkyl ester and a monomer having a reactive functional group in the molecule (reactive functional group-containing monomer) as monomer units constituting the polymer.

By containing a (meth)acrylic acid alkyl ester, the adhesive agent can exhibit preferable adhesiveness. The (meth)acrylic acid alkyl ester is preferably a (meth)acrylic acid alkyl ester having an alkyl group having 1 to 20 carbon atoms. The alkyl group may be linear or branched, or may have a cyclic structure.

As the (meth)acrylic acid alkyl ester having an alkyl group having 1 to 20 carbon atoms, it is preferable to contain one of which the homopolymer has a glass transition temperature (Tg) of −10° C. or less (hereinafter, referred to as “low Tg alkyl acrylate” in some cases). This makes it possible to improve the adhesiveness of the obtained adhesive agent as well as makes it easier to satisfy the physical properties described above.

Preferred examples of the low Tg alkyl acrylate include n-butyl acrylate (Tg: −55° C.), n-octyl acrylate (Tg: −65° C.), isooctyl acrylate (Tg: −58° C.), 2-ethylhexyl acrylate (Tg: −70° C.), isononyl acrylate (Tg: −58° C.), isodecyl acrylate (Tg: −60° C.), isodecyl methacrylate (Tg: −41° C.), n-lauryl methacrylate (Tg: −65° C.), tridecyl acrylate (Tg: −55° C.), tridecyl methacrylate (Tg: −40° C.), isobutyl acrylate (Tg: −26° C.), and ethyl acrylate (Tg: −20° C.). Among these, from the viewpoint of more effectively improving adhesiveness, the low Tg alkyl acrylate is preferably one of which the homopolymer has a Tg of −10° C. to −100° C., more preferably one of which the homopolymer has a Tg of −20° C. to −70° C. From the viewpoints of easily satisfying the physical properties described above and easily obtaining an adhesive agent that is suitable for the water pasting method, ethyl acrylate, isobutyl acrylate, n-butyl acrylate, and 2-ethylhexyl acrylate are particularly preferred. These may be used singly or in combination of two or more kinds thereof.

Meanwhile, the (meth)acrylic acid ester polymer (A) contains the low Tg alkyl acrylate as a monomer unit constituting the polymer preferably at 50% to 99% by mass, particularly preferably at 55% to 96% by mass, still more preferably at 60% to 93% by mass as an upper limit. This makes it possible to improve the adhesiveness of the obtained adhesive agent as well as makes it easier to satisfy the physical properties described above. In addition, the dispersibility of the ultraviolet absorbing agent and infrared absorbing agent described later in the adhesive agent tends to be favorable, and an adhesive agent that is likely to satisfy the optical properties described later can be obtained.

In addition, as the (meth)acrylic acid alkyl ester has an alkyl group having 1 to 20 carbon atoms, it is preferable to contain a monomer of which the homopolymer has a glass transition temperature (Tg) of more than 0° C. (hereinafter, referred to as a “high Tg alkyl acrylate” in some cases). This makes it easier for the creep compliance of the obtained adhesive agent to satisfy the aforementioned value.

Examples of the high Tg alkyl acrylate include methyl acrylate (Tg: 10° C.), methyl methacrylate (Tg: 105° C.), ethyl methacrylate (Tg: 65° C.), n-butyl methacrylate (Tg: 20° C.), isobutyl methacrylate (Tg: 48° C.), t-butyl methacrylate (Tg: 107° C.), n-stearyl acrylate (Tg: 30° C.), n-stearyl methacrylate (Tg: 38° C.), cyclohexyl acrylate (Tg: 15° C.), cyclohexyl methacrylate (Tg: 66° C.), benzyl methacrylate (Tg: 54° C.), isobornyl acrylate (Tg: 94° C.), isobornyl methacrylate (Tg: 180° C.), adamantyl acrylate (Tg: 115° C.), adamantyl methacrylate (Tg: 141° C.), and morpholine acrylate (Tg: 145° C.). Among these, from the viewpoint of cohesive force, the high Tg alkyl acrylate is preferably one of which the homopolymer has a Tg of 0° C. to 150° C., more preferably one of which the homopolymer has a Tg of 10° C. to 110° C. Methyl acrylate, methyl methacrylate, morpholine acrylate and isobornyl acrylate are preferred and methyl acrylate and methyl methacrylate are more preferred from the viewpoints of easily satisfying the physical properties described above and easily obtaining an adhesive agent that is suitable for the water pasting method, and methyl methacrylate still more preferred in some cases from the viewpoint of adhesiveness. These may be used singly or in combination of two or more kinds thereof.

In a case where the (meth)acrylic acid ester polymer (A) contains the high Tg alkyl acrylate as a monomer unit constituting the polymer, the content thereof is preferably 1% to 30% by mass, and is more preferably 3% to 20% by mass, particularly preferably 5% to 10% by mass from the viewpoint of easily adjusting the creep compliance to a desired value.

The (meth)acrylic acid ester polymer (A) contains a (meth)acrylic acid alkyl ester having an alkyl group having 1 to 20 carbon atoms as a monomer unit constituting the polymer preferably at 50% to 99% by mass, more preferably at 60% to 98% by mass, still more preferably at 70% to 97.5% by mass. This makes it possible to impart suitable adhesiveness to the (meth)acrylic acid ester polymer (A) as well as makes it easy to adjust the creep compliance to a low value. In addition, a desired amount of other monomer components can be introduced into the (meth)acrylic acid ester polymer (A). Hence, the dispersibility of the ultraviolet absorbing agent and infrared absorbing agent described later in the adhesive agent tends to be favorable, and an adhesive agent that is likely to satisfy the optical properties described later can be obtained.

In addition, by containing a reactive functional group-containing monomer, the (meth)acrylic acid ester polymer (A) reacts with the crosslinking agent (B) described later via the reactive functional group derived from the reactive functional group-containing monomer to form a crosslinked structure (three-dimensional network structure) in the adhesive agent. As a result, an adhesive agent having the desired cohesive force is obtained. The adhesive agent is likely to satisfy the physical properties relating to the creep compliance described above.

Preferred examples of the reactive functional group-containing monomer include a monomer having a hydroxyl group in the molecule (hydroxyl group-containing monomer), a monomer having a carboxy group in the molecule (carboxy group-containing monomer), and a monomer having an amino group in the molecule (amino group-containing monomer). These reactive functional group-containing monomers may be used singly or two or more kinds thereof may be used concurrently.

Among the reactive functional group-containing monomers, a hydroxyl group-containing monomer or a carboxy group-containing monomer is preferred. This makes it easier to satisfy the physical properties relating to the creep compliance described above.

Examples of the hydroxyl group-containing monomer include (meth)acrylic acid hydroxyalkyl esters such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate.

Among these, a (meth)acrylic acid hydroxyalkyl ester having a hydroxyalkyl group having 1 to 4 carbon atoms is preferred from the viewpoint of easily realizing the physical properties relating to the creep compliance described above. Specific preferred examples thereof include 2-hydroxyethyl (meth)acrylate and 4-hydroxybutyl (meth)acrylate, and particularly preferred examples thereof include 2-hydroxyethyl acrylate or 2-hydroxyethyl methacrylate. These may be used singly or in combination of two or more kinds thereof.

Examples of the carboxy group-containing monomer include ethylenically unsaturated carboxylic acids such as acrylic acid, methacrylic acid, crotonic acid, maleic acid, itaconic acid, and citraconic acid. Among these, acrylic acid is preferred from the viewpoint of the adhesive force of the (meth)acrylic acid ester polymer (A) obtained and the viewpoint of easily realizing the physical properties relating to the creep compliance described above. These may be used singly or in combination of two or more kinds thereof.

The (meth)acrylic acid ester polymer (A) contains a reactive functional group-containing monomer as a monomer unit constituting the polymer preferably at 1% to 30% by mass, more preferably at 1.5% to 22% by mass, still more preferably at 2% to 16% by mass, most preferably at 2.5% to 12% by mass.

By setting the content proportion of the reactive functional group-containing monomer to the above range, the cohesive force of the obtained adhesive agent by the crosslinking reaction of the (meth)acrylic acid ester polymer (A) with the crosslinking agent (B) is proper and the physical properties relating to the creep compliance described above are likely to be satisfied as well as the physical properties such as adhesive force and viscoelasticity are likely to be adjusted to suitable ranges. In addition, the dispersibility of the ultraviolet absorbing agent and infrared absorbing agent described later in the adhesive agent tends to be favorable, and an adhesive agent that is likely to satisfy the optical properties described later can be obtained.

In the present embodiment, the (meth)acrylic acid ester polymer (A) may contain another monomer as a monomer unit constituting the polymer, if desired. The other monomer is preferably a monomer not containing a reactive functional group in order not to inhibit the above-described action of the reactive functional group-containing monomer. Examples of such a monomer include non-reactive nitrogen atom-containing monomers such as N-vinyl-2-pyrrolidone, (meth)acrylic acid alkoxyalkyl esters such as methoxyethyl (meth)acrylate and ethoxyethyl (meth)acrylate, vinyl acetate, and styrene. Among these, it is preferable to contain vinyl acetate from the viewpoint of the adhesive force of the (meth)acrylic acid ester polymer (A) obtained and the viewpoint of easily realizing the physical properties relating to the creep compliance described above. These may be used singly or in combination of two or more kinds thereof.

The (meth)acrylic acid ester polymer (A) contains another monomer as a monomer unit constituting the polymer preferably at 1% to 15% by mass, more preferably at 2% to 10% by mass, still more preferably at 3% to 8% by mass. This makes it easier to satisfy the physical properties relating to the creep compliance described above as well as makes it easier to adjust the physical properties such as adhesive force and viscoelasticity to suitable ranges. In addition, the dispersibility of the ultraviolet absorbing agent and infrared absorbing agent described later in the adhesive agent tends to be favorable, and an adhesive agent that is likely to satisfy the optical properties described later can be obtained.

The polymerization aspect of the (meth)acrylic acid ester polymer (A) may be a random copolymer or a block copolymer.

The weight average molecular weight of the (meth)acrylic acid ester polymer (A) is preferably 200000 to 2000000, more preferably 300000 to 1400000, still more preferably 400000 to 1100000, particularly preferably 450000 to 900000, and among these, is preferably 500000 to 800000. This makes it easier to satisfy the physical properties relating to the creep compliance described above as well as makes it easier to adjust the physical properties such as adhesive force and viscoelasticity to suitable ranges. In addition, the dispersibility of the ultraviolet absorbing agent and infrared absorbing agent described later in the adhesive agent tends to be favorable, and an adhesive agent that is likely to satisfy the optical properties described later can be obtained. Incidentally, the weight average molecular weight in the present specification is a value that is measured by gel permeation chromatography (GPC) and calculated in terms of standard polystyrene.

In the adhesive composition P, the (meth)acrylic acid ester polymer (A) may be used singly or in combination of two or more kinds thereof.

### (1.3.2. Crosslinking Agent (B))

The crosslinking agent (B) in the present embodiment crosslinks the (meth)acrylic acid ester polymer (A) to form a crosslinked structure (three-dimensional network structure) by heating or the like of the adhesive composition P containing the crosslinking agent (B). As a result, the cohesive force of the obtained adhesive agent is improved, and the physical properties relating to the creep compliance described above are likely to be satisfied.

The crosslinking agent (B) may be one that reacts with the reactive group of the (meth)acrylic acid ester polymer (A). Examples thereof include an isocyanate-based crosslinking agent, an epoxy-based crosslinking agent, an amine-based crosslinking agent, a melamine-based crosslinking agent, an aziridine-based crosslinking agent, a hydrazine-based crosslinking agent, an aldehyde-based crosslinking agent, an oxazoline-based crosslinking agent, a metal alkoxide-based crosslinking agent, a metal chelate-based crosslinking agent, a metal salt-based crosslinking agent, and an ammonium salt-based crosslinking agent. Among these, an epoxy-based crosslinking agent, a metal chelate-based crosslinking agent, an isocyanate-based crosslinking agent, and the like are preferred, and it is more preferable to use an epoxy-based crosslinking agent and a metal chelate-based crosslinking agent concurrently. Incidentally, the crosslinking agent (B) may be used singly or in combination of two or more kinds thereof.

Examples of the epoxy-based crosslinking agent include 1,3-bis(N,N-diglycidylaminomethyl)cyclohexane, N,N,N′,N′-tetraglycidyl-m-xylylenediamine, ethylene glycol diglycidyl ether, 1,6-hexanediol diglycidyl ether, trimethylolpropane diglycidyl ether, diglycidylaniline, and diglycidylamine. Among these, N,N,N′,N′-tetraglycidyl-m-xylylenediamine is preferred from the viewpoint of reactivity with a carboxy group and the viewpoint of weather resistance.

As the metal chelate-based crosslinking agent, a metal chelate compound in which the metal atom is aluminum, zirconium, titanium, zinc, iron, tin, or the like can be used. Among these, an aluminum chelate compound is preferred.

Examples of the aluminum chelate compound include aluminum trisacetylacetonate, aluminum trisethylacetoacetate, and aluminum ethylacetoacetate diisopropylate, and aluminum trisacetylacetonate is preferred from the viewpoint of weather resistance.

The isocyanate-based crosslinking agent contains at least a polyisocyanate compound. Examples of the polyisocyanate compound include aromatic polyisocyanates such as tolylene diisocyanate, diphenylmethane diisocyanate, and xylylene diisocyanate; aliphatic polyisocyanates such as hexamethylene diisocyanate; and alicyclic polyisocyanates such as isophorone diisocyanate and hydrogenated diphenylmethane diisocyanate; and biuret products and isocyanurate products thereof, and further adduct products that are reaction products thereof with low molecular weight active hydrogen-containing compounds such as ethylene glycol, propylene glycol, neopentyl glycol, trimethylolpropane, and castor oil. Among these, trimethylolpropane-modified aromatic polyisocyanates are preferred and trimethylolpropane-modified tolylene diisocyanate is particularly preferred from the viewpoint of reactivity with a hydroxyl group. In addition, from the viewpoint of weather resistance, aliphatic polyisocyanates and alicyclic polyisocyanates are preferred, a biuret product of an aliphatic polyisocyanate is more preferred, and a biuret product of hexamethylene diisocyanate is particularly preferred.

The content of the crosslinking agent (B) in the adhesive composition P is preferably 0.01 to 5 parts by mass, more preferably 0.05 to 2 parts by mass, particularly preferably 0.1 to 1 part by mass, still more preferably 0.1 to 0.8 parts by mass with respect to 100 parts by mass of the (meth)acrylic acid ester polymer (A), and among these, is preferably 0.2 to 0.6 parts by mass, most preferably 0.3 to 0.5 parts by mass. This makes it easier to satisfy the physical properties relating to the creep compliance described above as well as makes it easier to adjust the physical properties such as adhesive force and viscoelasticity to suitable ranges.

In a case where an epoxy-based crosslinking agent and a metal chelate-based crosslinking agent are used concurrently, the content of the epoxy-based crosslinking agent in the adhesive composition P is preferably 0.01 to 2 parts by mass, more preferably 0.05 to 1 part by mass, particularly preferably 0.08 to 0.5 parts by mass, still more preferably 0.1 to 0.2 parts by mass with respect to 100 parts by mass of the (meth)acrylic acid ester polymer (A). Meanwhile, the content of the metal chelate-based crosslinking agent in the adhesive composition P is preferably 0.01 to 3 parts by mass, more preferably 0.08 to 1 part by mass, particularly preferably 0.1 to 0.8 parts by mass, still more preferably 0.2 to 0.5 parts by mass with respect to 100 parts by mass of the (meth)acrylic acid ester polymer (A). As an epoxy-based crosslinking agent and a metal chelate-based crosslinking agent are used concurrently in the contents described above, the physical properties relating to the creep compliance described above are likely to be satisfied as well as the physical properties such as adhesive force and viscoelasticity are likely to be adjusted to suitable ranges.

### (1.3.3. Ultraviolet Absorbing Agent (C))

The adhesive agent according to the present embodiment preferably contains an ultraviolet absorbing agent, and more preferably contains an ultraviolet absorbing agent excellent in ultraviolet absorbing properties, which is capable of adjusting the ultraviolet transmittance described later to a desired range, in order to impart an ultraviolet shielding function to the window film. This allows the window film according to the present embodiment to exert favorable ultraviolet absorbing properties when the attachment surface is the surface of a window on the side where direct sunlight enters or when the attachment surface is the surface of the window on the opposite side.

Examples of the ultraviolet absorbing agent include benzophenone-based, benzotriazole-based, benzoate-based, benzoxazinone-based, methine-based, triazine-based, phenyl salicylate-based, cyanoacrylate-based, and nickel complex salt-based compounds, and the ultraviolet absorbing agent may be used singly or in combination of two or more kinds thereof. Among the ultraviolet absorbing agents (C), it is preferable to use benzophenone-based, benzotriazole-based, and triazine-based compounds and it is more preferable to use triazine-based compounds.

Examples of the triazine-based compounds include 2,4-bis(2-hydroxy-4-butoxyphenyl)-6-(2,4-dibutoxyphenyl)-1,3,5-triazine, 2,4,6-tris(2-hydroxy-4-octyloxyphenyl)-1,3,5-triazine, 2,4,6-tris[2-hydroxy-4-(3-butoxy-2-hydroxypropyloxy)phenyl]-1,3,5-triazine, and 2,4,6-tris(2-hydroxy-4-hexyloxy-3-methylphenyl)-1,3,5-triazine.

Examples of the benzophenone-based compounds include 2,2′-dihydroxy-4-methoxybenzophenone, 2,2′-dihydroxy-4,4′-dimethoxybenzophenone, 2,2′,4,4′-tetrahydroxybenzophenone, 2-hydroxy-4-methoxybenzophenone, 2,4-dihydroxybenzophenone, and 2-hydroxy-4-octoxybenzophenone.

Examples of the benzotriazole-based compounds include 2-(2′-hydroxy-3′,5′-di-tert-butylphenyl)-5-chlorobenzotriazole, 2-(2′-hydroxy-3′-tert-butyl-5′-methylphenyl)-5-chlorobenzotriazole, 2-(2′-hydroxy-3′-tert-amyl-5′-isobutylphenyl)-5-chlorobenzotriazole, 2-(2′-hydroxy-3′-isobutyl-5′-methylphenyl)-5-chlorobenzotriazole, 2-(2′-hydroxy-3′-isobutyl-5′-propylphenyl)-5-chlorobenzotriazole, 2-(2′-hydroxy-3′,5′-di-tert-butylphenyl)benzotriazole, 2-(2′-hydroxy-5′-methylphenyl)benzotriazole, and 2-[2′-hydroxy-5′-(1,1,3,3-tetramethyl)phenyl]benzotriazole.

The content of the ultraviolet absorbing agent (C) in the adhesive composition P is preferably 0.1 to 25 parts by mass, more preferably 1 to 18 parts by mass, still more preferably 3 to 12 parts by mass, particularly preferably 5 to 8 parts by mass with respect to 100 parts by mass of the (meth)acrylic acid ester polymer (A). This allows the adhesive agent layer obtained to exert excellent ultraviolet shielding properties. In addition, a window film that satisfies the optical properties such as ultraviolet transmittance and haze value described later can be obtained.

When the content of the ultraviolet absorbing agent (C) in 100% by mass of the adhesive agent is denoted as X % by mass, X % by mass is preferably a value that satisfies the following Formula (I) where the thickness of the adhesive agent layer is denoted as Z μm.

$$10 \leq X \times Z \leq 250 \qquad ( I )$$

As X×Z is within the above range, a window film that satisfies the optical properties such as ultraviolet transmittance and haze value described later can be obtained.

From the above viewpoint, X×Z is preferably 30 to 200, more preferably 50 to 150, and still more preferably 60 to 135.

From the viewpoint of making it easier for the value of X×Z to fall within the above range, the content (X % by mass) of the ultraviolet absorbing agent (C) in the adhesive agent is preferably 0.1% to 25% by mass, more preferably 1% to 18% by mass, still more preferably 3% to 12% by mass, particularly preferably 5% to 8% by mass.

### (1.3.4. Infrared Absorbing Agent (D))

The adhesive agent according to the present embodiment preferably contains an infrared absorbing agent, and more preferably contains an infrared absorbing agent excellent in near-infrared absorbing properties, which is capable of adjusting the near-infrared transmittance described later to a desired range, in order to impart heat shielding performance. This allows the window film according to the present embodiment to exert favorable heat shielding performance when the attachment surface is the surface of a window on the side where direct sunlight enters or when the attachment surface is the surface of the window on the opposite side.

Examples of the infrared absorbing agent (D) include organic infrared absorbing agents and inorganic infrared absorbing agents.

Examples of the organic infrared absorbing agents include a cyanine-based compound, a squarylium-based compound, a thiol nickel complex salt-based compound, a naphthalocyanine-based compound, a phthalocyanine-based compound, a triarylmethane-based compound, a naphthoquinone-based compound, an anthraquinone-based compound, and further amino compounds such as perchlorate salt of N,N,N′,N′-tetrakis(p-di-n-butylaminophenyl)-p-phenylenediaminium, chlorate salt of phenylenediaminium, hexafluoroantimonate salt of phenylenediaminium, fluoroborate salt of phenylenediaminium, fluoride salt of phenylenediaminium, and perchlorate salt of phenylenediaminium; and phosphate ester copper compounds obtained by the reaction of a copper compound with a bisthiourea compound, a phosphorus compound, and a phosphate ester compound. The organic infrared absorbing agent can be appropriately selected depending on weather resistance and required optical properties.

Examples of the inorganic infrared absorbing agents include titanium oxide, zirconium oxide, tantalum oxide, niobium oxide, zinc oxide, indium oxide, tin-doped indium oxide (ITO), tin oxide, antimony-doped tin oxide (ATO), zinc antimonate, cesium oxide, zinc sulfide, hexaborides (LaB₆, CeB₆, PrB₆, NdB₆, GdB₆, TbB₆, DyB₆, HoB₆, YB₆, SmB₆, EuB₆, ErB₆, TmB₆, YbB₆, LuB₆, SrB₆, CaB₆, and the like), and tungsten oxide-based compounds. Among these, tungsten oxide-based compounds, tin-doped indium oxide (ITO), and antimony-doped tin oxide (ATO) are preferred, and tungsten oxide-based compounds are particularly preferred.

Examples of the tungsten oxide-based compounds include a compound represented by the following General Formula (1).

MₘWOₙ (1)

(In the formula, the element M represents one or more elements selected from among H, He, an alkali metal, an alkaline earth metal, a rare earth element, Zr, Cr, Mn, Fe, Ru, Co, Rh, Ir, Ni, Pd, Pt, Cu, Ag, Au, Zn, Cd, Al, Ga, In, Tl, Si, Ge, Sn, Pb, Sb, B, F, P, S, Se, Br, Te, Ti, Nb, V, Mo, Ta, Re, Be, Hf, Os, Bi, and I, and m and n are numbers that satisfy 0.001≤m≤1.0 and 2.2≤n≤3.0.)

Preferred examples of the element M in the tungsten oxide-based compound represented by General Formula (1) include tungsten oxide-based compounds containing one or more elements selected from among the respective elements of Cs, Rb, K, Tl, In, Ba, Li, Ca, Sr, Fe, and Sn. Among these, Cs is preferred, that is, cesium-containing tungsten oxide is preferred from the viewpoint of easily adjusting the optical properties such as near-infrared transmittance, visible light transmittance, and haze described later to desired ranges. Examples of such cesium-containing tungsten oxide include “YMF-02AS” manufactured by Sumitomo Metal Mining Co., Ltd., which can be preferably used.

In the present embodiment, the infrared absorbing agent is preferably an inorganic infrared absorbing agent from the viewpoint of near-infrared transmittance described later and the viewpoint of weather resistance. Incidentally, the infrared absorbing agent (D) can be used singly or in combination of two or more kinds thereof.

In the present embodiment, it is preferable to use fine particles having irregular shape or regular shape as the infrared absorbing agent. In addition, in a case where the infrared absorbing agent is fine particles, the average particle size thereof is preferably 1 to 800 nm, more preferably 5 to 300 nm from the viewpoint of easily satisfying the optical properties such as near-infrared transmittance, visible light transmittance, and haze described later.

In a case where the adhesive agent according to the present embodiment contains an infrared absorbing agent of fine particles, it is preferable that the fine particles are noticed when a cross section of the adhesive agent layer is observed using a SEM or the like.

In a case where the adhesive agent according to the present embodiment contains an infrared absorbing agent, it is preferable that any one of Cs, W or O is detected and it is particularly preferable that Cs or W is detected when a cross section of the adhesive agent layer is subjected to composition analysis using an instrument such as XPS.

The content of the infrared absorbing agent (D) in the adhesive composition P is preferably 1 to 80 parts by mass, more preferably 3 to 60 parts by mass with respect to 100 parts by mass of the (meth)acrylic acid ester polymer (A). This makes it possible to obtain a window film that satisfies the optical properties such as near-infrared transmittance and haze value described later. From the viewpoint of obtaining a window film that realizes a desired near-infrared transmittance without containing an infrared absorbing agent in layers other than the adhesive agent layer, such as a hard coat layer, the content is still more preferably 8 to 50 parts by mass, particularly preferably 16 to 40 parts by mass, and among these, is preferably 24 to 35 parts by mass.

When the content of the infrared absorbing agent (D) in 100% by mass of the adhesive agent is denoted as Y % by mass, it is preferable that Y % by mass is a value that satisfies the following Formula (II) where the thickness of the adhesive agent layer is denoted as Z μm.

$$10 \leq Y \times Z \leq 1000 \qquad ( II )$$

As Y×Z is within the above range, a window film that satisfies the optical properties such as near-infrared transmittance and haze value described later can be obtained.

Y×Z is preferably 50 to 800 from the viewpoint, and is more preferably 100 to 600, still more preferably 200 to 500 from the viewpoint of satisfying the desired near-infrared transmittance and suppressing glue slippage at the same time.

From the viewpoint of making it easier for the value of Y×Z to fall within the above range, the content (Y % by mass) of the infrared absorbing agent (D) in the adhesive agent is preferably 1% to 80% by mass, more preferably 3% to 60% by mass, still more preferably 6% to 40% by mass, particularly preferably 10% to 30% by mass.

### (1.3.5. Other Additives)

The adhesive composition P may contain additives that are commonly used in acrylic adhesive agents, if necessary. Examples of such additives include tackifiers, silane coupling agents, fillers, softeners, antioxidants, light stabilizers, crosslinking agents, coloring agents, modifiers, rust inhibitors, flame retardants, hydrolysis inhibitors, surface lubricants, corrosion inhibitors, heat stabilizers, lubricants, antistatic agents, polymerization inhibitors, catalysts, leveling agents, thickeners, dispersants, antifoaming agents, and surfactants. Incidentally, the polymerization solvent and dilution solvent described later are not included in the additives that constitute the adhesive composition P.

### (1.4. Hard Coat Layer)

The window film according to the present embodiment preferably includes a hard coat layer in addition to the substrate and the adhesive agent layer. In the present embodiment, as illustrated in FIG. 1B, a hard coat layer 12 is preferably disposed on a main surface 10b of a substrate 10 opposite to a main surface 10a on which an adhesive agent layer 11 is disposed. Furthermore, it is also preferable that the hard coat layer is disposed between the substrate 10 and the adhesive agent layer 11.

The hard coat layer is formed of a material that is superior in hardness, scratch resistance, weather resistance, and the like to the substrate. Moreover, since the adhesive agent layer of the window film is attached to the adherend, the hard coat layer of the window film is exposed to the outside. Therefore, as the window film includes the hard coat layer, the generation of scratches on the surface of the window film due to pressing force by a squeegee such as a spatula during installation by water pasting is suppressed. In addition, since the surface hardness of the window film can be increased, the stress applied to the window film by the pressing force of a squeegee such as a spatula tends to be less likely to be transmitted directly to the adhesive agent layer, and deformation of the adhesive agent can be decreased. For this reason, the glue slippage described above can be suppressed. Moreover, after installation as well, even if some external force is applied, it is possible to make it difficult for the external force to be directly transmitted to the adhesive agent layer and the adherend (such as the window of a motor vehicle or building), and thus excellent impact resistance can be exerted. Furthermore, even if the adherend is broken, the fragments thereof can be prevented from scattering, and thus excellent shatterproof properties can be exerted. Therefore, safety can be enhanced while the appearance of moving objects such as motor vehicles and buildings is maintained.

From the viewpoint of surface hardness, scratch resistance, and weather resistance of the window film, the thickness of the hard coat layer is preferably 0.5 to 20 μm, more preferably 1 to 15 μm, particularly preferably 2 to 10 μm, and among these, is preferably 3 to 6 μm.

The material constituting the hard coat layer is not particularly limited as long as it is a material that is superior in hardness, scratch resistance, weather resistance, and the like to the substrate. The hard coat layer according to the present embodiment is preferably a cured product of a composition for hard coat layer formation that contains an energy ray-curable resin.

### (1.4.1. Composition for Hard Coat Layer Formation)

In the present embodiment, a composition for hard coat layer formation Q may be composed of a thermosetting material or an energy ray-curable material, but is preferably composed of an energy ray-curable material from the viewpoint of productivity and the viewpoint of easily obtaining desired scratch resistance, more preferably contains an energy ray-curable resin (a), and still more preferably contains an energy ray-curable resin (a) and a photopolymerization initiator (b).

### (1.4.2. Energy Ray-Curable Resin (a))

The energy ray-curable resin is not particularly limited and can be selected from conventionally known resins. Examples thereof include an energy ray-curable monomer, an energy ray-curable oligomer, or compositions containing these.

Examples of the energy ray-curable monomer include a polyfunctional (meth)acrylate. Examples of the energy ray-curable oligomer include urethane (meth)acrylate, polyester (meth)acrylate, polyether (meth)acrylate, and silicone (meth)acrylate.

Examples of the polyfunctional (meth)acrylate include 1,4-butanediol di(meth)acrylate, 1,6-hexanediol di(meth)acrylate, neopentyl glycol di(meth)acrylate, ethylene glycol di(meth)acrylate, propylene glycol di(meth)acrylate, hexanediol di(meth)acrylate, trimethylolethane tri(meth)acrylate, trimethylolpropane tri(meth)acrylate, pentaerythritol polyfunctional (meth)acrylates such as pentaerythritol tri(meth)acrylate and pentaerythritol tetra(meth)acrylate, dipentaerythritol polyfunctional (meth)acrylates such as dipentaerythritol penta(meth)acrylate and dipentaerythritol hexa(meth)acrylate, glycerol tri(meth)acrylate, and triallyl (meth)acrylate.

Among these, a pentaerythritol polyfunctional (meth)acrylate or a dipentaerythritol polyfunctional (meth)acrylate is more preferred since proper hardness, scratch resistance, weather resistance, and the like can be imparted to the hard coat layer.

### (1.4.3. Photopolymerization Initiator (b))

In a case where ultraviolet rays are used as the energy rays for curing the composition for hard coat layer formation Q, the composition for hard coat layer formation Q preferably contains a photopolymerization initiator (b). By containing a photopolymerization initiator, a hard coat layer can be efficiently formed when the composition for hard coat layer formation Q is irradiated with ultraviolet rays.

Here, the photopolymerization initiator refers to a compound that generates radical species by being irradiated with active energy rays such as ultraviolet rays.

Examples of the photopolymerization initiator include benzoin, benzoin methyl ether, benzoin ethyl ether, benzoin isopropyl ether, benzoin-n-butyl ether, benzoin isobutyl ether, acetophenone, dimethylaminoacetophenone, 2,2-dimethoxy-2-phenylacetophenone, 2,2-diethoxy-2-phenylacetophenone, 2-hydroxy-2-methyl-1-phenylpropan-1-one, 2-hydroxy-1-{4-[4-(2-hydroxy-2-methylpropionyl)benzyl]phenyl}-2-methylpropan-1-one, 1-hydroxycyclohexyl phenyl ketone, 2-methyl-1-[4-(methylthio)phenyl]-2-morpholinopropanon-1-one, 4-(2-hydroxyethoxy)phenyl-2-(hydroxy-2-propyl)ketone, benzophenone, p-phenylbenzophenone, 4,4-diethylaminobenzophenone, dichlorobenzophenone, 2-methylanthraquinone, 2-ethylanthraquinone, 2-tertiary butylanthraquinone, 2-aminoanthraquinone, 2-methylthioxanthone, 2-ethylthioxanthone, 2-chlorothioxanthone, 2,4-dimethylthioxanthone, 2,4-diethylthioxanthone, benzil dimethyl ketal, acetophenone dimethyl ketal, p-dimethylamino-benzoic acid ester, and oligo[2-hydroxy-2-methyl-1-[4-(1-methylvinyl)phenyl]propan-1-one]. These may be used singly or in combination of two or more kinds thereof.

The content of the photopolymerization initiator (b) is preferably 1 to 30 parts by mass, more preferably 2 to 20 parts by mass, and still more preferably from 4 to 10 parts by mass with respect to 100 parts by mass of the energy ray-curable resin (a). This makes it easier for the hard coat layer obtained to exert the desired surface hardness and scratch resistance.

### (1.4.4. Infrared Absorbing Agent (c))

The composition for hard coat layer formation Q according to the present embodiment also preferably contains an infrared absorbing agent (c). Examples of the kind of the infrared absorbing agent (c) include the same infrared absorbing agents as those described in “1.3.4. Infrared absorbing agent (D)” above, and the same applies to the kind of the preferred infrared absorbing agent in the case of being contained in the composition for hard coat layer formation Q.

The content of the infrared absorbing agent (c) in the composition for hard coat layer formation Q is preferably 10 to 100 parts by mass, more preferably 30 to 90 parts by mass with respect to 100 parts by mass of the energy ray-curable resin (a). This makes it possible to obtain a window film that satisfies the optical properties such as near-infrared transmittance and haze value described later. From the viewpoint of obtaining a window film that realizes a desired near-infrared transmittance without containing an infrared absorbing agent in layers other than the hard coat layer, such as an adhesive agent layer, the content is particularly preferably 50 to 85 parts by mass, and among these, is preferably 60 to 80 parts by mass.

In a case where the hard coat layer according to the present embodiment contains an infrared absorbing agent of fine particles, it is preferable that the fine particles are noticed when a cross section of the hard coat layer is observed using a SEM or the like.

In a case where the hard coat layer according to the present embodiment contains an infrared absorbing agent, it is preferable that any one of Cs, W, or O is detected and it is particularly preferable that Cs or W is detected when a cross section of the hard coat layer is subjected to composition analysis using an instrument such as XPS.

When the content of the infrared absorbing agent (c) in 100% by mass of the hard coat layer is denoted as α % by mass, it is preferable that α % by mass is a value that satisfies the following Formula (III) where the thickness of the hard coat layer is denoted as H μm.

$$10 \leq α \times H \leq 1000 \qquad ( III )$$

As α×H is within the above range, a window film that satisfies the optical properties such as near-infrared transmittance and haze value described later can be obtained.

From the above viewpoint, α×H is preferably 50 to 800, more preferably 100 to 600, still more preferably 150 to 400, and still more preferably 200 to 300.

From the viewpoint of making it easier for the value of α×H to fall within the above range, the content (α % by mass) of the infrared absorbing agent (c) in the hard coat layer is preferably 1% to 80% by mass, more preferably 20% to 60% by mass, still more preferably 30% to 50% by mass.

Incidentally, in the present embodiment, it is also preferable that the hard coat layer does not contain an infrared absorbing agent from the viewpoint of scratch resistance of the window film. As an infrared absorbing agent is not contained, it is possible to increase the content ratio of energy ray-curable resin in the hard coat layer and to separately blend a material that can enhance scratch resistance, and thus a design that enhances scratch resistance and surface hardness is likely to be taken.

### (1.4.5. Coloring Agent (d))

The composition for hard coat layer formation Q according to the present embodiment also preferably contains a coloring agent (d). By containing a coloring agent, optical properties such as visible light transmittance described later can be adjusted, and for example, the privacy protecting properties of the window film can be enhanced by applying the window film to the windows of a motor vehicle and a building.

The coloring agent (d) may be a pigment or a dye. The pigment may be an organic pigment or an inorganic pigment. From the viewpoint of durability of the hard coat layer obtained, an inorganic pigment is preferred. The color of the coloring agent can be appropriately selected to match the color of surrounding members such as window frames as well as to exert privacy protecting properties, but generally, is preferably a dark or deep color such as black, brown, navy blue, purple, or blue, and is particularly preferably black.

Examples of the organic pigment and organic dye include an aminium-based coloring matter, a cyanine-based coloring matter, a merocyanine-based coloring matter, a croconium-based coloring matter, a squalium-based coloring matter, an azulenium-based coloring matter, a polymethine-based coloring matter, a naphthoquinone-based coloring matter, a pyrylium-based coloring matter, a phthalocyanine-based coloring matter, a naphthalocyanine-based coloring matter, a naphtholactam-based coloring matter, an azo-based coloring matter, a condensed azo-based coloring matter, an indigo-based coloring matter, a perinone-based coloring matter, a perylene-based coloring matter, a dioxazine-based coloring matter, a quinacridone-based coloring matter, an isoindolinone-based coloring matter, a quinophthalone-based coloring matter, a pyrrole-based coloring matter, a thioindigo-based coloring matter, a metal complex-based coloring matter (metal complexed dye), a dithiol metal complex-based coloring matter, an indolephenol-based coloring matter, a triarylmethane-based coloring matter, an anthraquinone-based coloring matter, a dioxazine-based coloring matter, a naphthol-based coloring matter, an azomethine-based coloring matter, a benzimidazolone-based coloring matter, a pyranthrone-based coloring matter, and a threne-based coloring matter.

Examples of the inorganic pigment include carbon black, a cobalt-based coloring matter, an iron-based coloring matter, a chromium-based coloring matter, a titanium-based coloring matter, a vanadium-based coloring matter, a zirconium-based coloring matter, a molybdenum-based coloring matter, a ruthenium-based coloring matter, a platinum-based coloring matter, an ITO (indium tin oxide)-based coloring matter, and an ATO (antimony tin oxide)-based pigment.

Examples of black pigments include carbon black, copper oxide, ferrosoferric oxide, manganese dioxide, aniline black, and activated carbon. In addition, examples of black dyes include high-concentration vegetable dyes and azo dyes.

The pigments or dyes can be appropriately mixed and used so that the intended physical properties of the hard coat layer are obtained.

Among the coloring agents, carbon black, a nigrosine-based black dye, and a chromate salt-based black dye are preferred and carbon black is more preferred from the viewpoints of favorable applicability to the hard coat layer, easily satisfying the optical properties of the window film described later, and easily exerting privacy protecting properties. Incidentally, the surface of carbon black may be or may not be subjected to a predetermined treatment (for example, a treatment to make it solvent-philic).

With regard to the coloring agent (d), the average haze that is the average value of the haze value at a wavelength of 780 nm and the haze value at a wavelength of 380 nm of a solution obtained by diluting the coloring agent with ethyl acetate by 10000 times is preferably 1% to 20%, more preferably 2% to 10%. As such a coloring agent is used in the hard coat layer, the optical properties such as visible light transmittance and haze value described later of the window film according to the present embodiment can be adjusted.

With regard to the coloring agent (d), the difference between the haze value at a wavelength of 780 nm and the haze value at a wavelength of 380 nm of a solution obtained by diluting the coloring agent with ethyl acetate by 10000 times is preferably 0 to 20 points, more preferably 4 to 10 points. As such a coloring agent is used in the hard coat layer, the optical properties such as visible light transmittance and haze value described later of the window film according to the present embodiment can be adjusted.

With regard to the coloring agent (d), the haze value at a wavelength of 780 nm of a solution obtained by diluting the coloring agent with ethyl acetate by 10000 times is preferably 0.10% to 20%, more preferably 10% to 10%. In addition, the haze value at a wavelength of 380 nm of a solution obtained by diluting the coloring agent with ethyl acetate by 10000 times is preferably 1% to 20%, more preferably 5% to 12%. This makes it easier to satisfy the average haze, the difference in haze values, and the standard deviation of the haze values described later. As such a coloring agent is used in the hard coat layer, the optical properties such as visible light transmittance and haze value described later of the window film according to the present embodiment can be adjusted.

With regard to the coloring agent (d), the standard deviation of the haze values at the respective wavelengths in the wavelength region of 380 nm to 780 nm at a 5 nm pitch (that is, 380 nm, 385 nm, 390 nm, . . . , 775 nm, 780 nm) of a solution obtained by diluting the coloring agent with ethyl acetate by 10000 times is preferably 0 to 10, more preferably 0.1 to 5, particularly preferably 1 to 3. As such a coloring agent is used in the hard coat layer, the optical properties such as visible light transmittance and haze value described later of the window film according to the present embodiment can be adjusted.

The content of the coloring agent (d) is preferably 0.1 to 30 parts by mass, more preferably 0.5 to 20 parts by mass, and still more preferably 1 to 10 parts by mass with respect to 100 parts by mass of the energy ray-curable resin (a). This makes it possible to adjust the optical properties such as visible light transmittance and haze value described later of the window film according to the present embodiment as well as to exert favorable privacy protecting properties.

When the content of the coloring agent (d) in 100% by mass of the hard coat layer is denoted as β % by mass, the β % by mass is preferably a value that satisfies the following Formula (IV) where the thickness of the hard coat layer is denoted as H m.

$$1 \leq β \times H \leq 200 \qquad ( IV )$$

As β×H is within the above range, a window film that satisfies the optical properties such as near-infrared transmittance and haze value described later can be obtained.

From the above viewpoint, β×H is preferably 5 to 100, more preferably 10 to 50, and still more preferably 12 to 20.

From the viewpoint of making it easier for the value of β×H to fall within the above range, the content (β % by mass) of the coloring agent (d) in the hard coat layer is preferably 0.1% to 30% by mass, more preferably 0.5% to 20% by mass, still more preferably 1% to 10% by mass.

### (1.4.6. Other Additives)

In addition, the composition for hard coat layer formation Q according to the present embodiment can appropriately contain other additives as long as the effects of the present invention are not impaired. Examples of the other additives include antioxidants, antistatic agents, polymerization accelerators, polymerization inhibitors, plasticizers, leveling agents, antiviral agents, antibacterial agents, fillers, and dilution solvents.

### (1.5. Physical Properties of Window Film)

The window film according to the present embodiment has the following physical properties.

The window film according to the present embodiment preferably has a light transmittance (near-infrared transmittance) of 60% or less in the wavelength range of 780 to 2500 nm. This allows the window film to shield infrared rays and exert favorable infrared heat shielding performance. This makes it possible to suppress the rise in surface temperature of members and people inside buildings and motor vehicles as well as to suppress the rise in temperature in the internal space.

From the above viewpoints, the near-infrared transmittance is preferably 50% or less, preferably 40% or less, more preferably 30% or less, still more preferably 20% or less, particularly preferably 10% or less, and among these, is preferably 5% or less, most preferably 1% or less. The lower limit of the near-infrared transmittance is usually 0% or more.

The window film according to the present embodiment preferably has a light transmittance (ultraviolet transmittance) of 10% or less in the wavelength range of 300 to 380 nm. This allows the window film to exert favorable ultraviolet shielding function. This makes it possible to suppress deterioration of members inside buildings and motor vehicles as well as to prevent people inside buildings and motor vehicles from suffering from rough skin and sunburn.

From the above viewpoints, the ultraviolet transmittance is preferably 5% or less, more preferably 1% or less, and most preferably 0%. The lower limit of the ultraviolet transmittance is usually 0% or more.

The window film according to the present embodiment preferably has a light transmittance (visible light transmittance) of 98% or less in the wavelength range of 380 to 780 nm. This allows the presence of the window to be visually recognized. For example, highly transparent window glass and the like are extremely excellent in visibility, but there is a risk that the window is broken when someone bumps into the window without noticing the presence of the window, and thus it is preferable that the window is highly transparent while the presence of the window can be recognized from the viewpoint of safety. From such a viewpoint, the visible light transmittance is preferably 90% or less, more preferably 85% or less. Furthermore, from the viewpoint of making it difficult to see the circumstances inside buildings and inside motor vehicles through windows, that is, the viewpoint of privacy protecting properties, the visible light transmittance is preferably 80% or less, more preferably 70% or less, still more preferably 60% or less, particularly preferably 50% or less, and among these, is preferably 40% or less. Incidentally, for windows that do not require visibility, there is also a case where the visible light transmittance is preferably 0% from the viewpoint of privacy protecting properties.

In a case where visibility through windows is required, the visible light transmittance is preferably 1% or more, more preferably 5% or more, still more preferably 15% or more, particularly preferably 30% or more from the viewpoint of improving visibility. This allows the scenery outside the window to be favorably seen through the window of a building and allows the circumstances outside the vehicle to be favorably recognized through the window of a motor vehicle, and safety during driving is enhanced.

The window film according to the present embodiment has a haze of preferably 10% or less, more preferably 5% or less, particularly preferably 3% or less. This provides the window film with excellent transparency. The lower limit of the haze is usually 0% or more.

Incidentally, the near-infrared transmittance, ultraviolet transmittance, visible light transmittance, and haze of the window film described above can be measured by the methods presented in Test Examples described later.

With respect to the window film according to the present embodiment, when #0000 steel wool is moved back and forth over the hard coat layer 10 times while being pressed at 250 g/cm² and then the place on the hard coat layer where the steel wool has been moved is visually observed, the hard coat layer preferably has five or fewer scratches, and more preferably has no scratches noticed. This suppresses the generation of scratches on the surface of the window film due to pressing force by a squeegee such as a spatula during installation by water pasting. In addition, after installation as well, the surface is less likely to be scratched, so the appearance of the adherend of the window film can be maintained as well as excellent shatterproof properties can also be exerted. The scratch resistance can be measured by the method presented in Test Examples described later.

The total thickness of the window film according to the present embodiment is preferably 5 to 200 μm, more preferably 10 to 160 μm, particularly preferably 15 to 140 μm. This makes it easier to reduce the stress applied to the adhesive agent during installation by water pasting. Moreover, the total thickness of the window film is preferably 20 to 70 μm, particularly preferably 25 to 55 μm from the viewpoint of mainly taking a design in which the optical properties described later are adjusted by layers other than the substrate and the viewpoint of obtaining a thin window film. In addition, the total thickness of the window film is preferably 55 to 120 μm, particularly preferably 70 to 100 μm from the viewpoint of including a design in which the optical properties described later are adjusted in the substrate.

### (1.6. Production of Adhesive Composition)

The adhesive composition P can be produced, for example, by first producing the (meth)acrylic acid ester polymer (A) and mixing the obtained (meth)acrylic acid ester polymer (A) with the crosslinking agent (B). If necessary, additives may be added.

The (meth)acrylic acid ester polymer (A) can be produced, for example, by polymerizing a mixture of monomers constituting the polymer by an ordinary radical polymerization method. The polymerization of the (meth)acrylic acid ester polymer (A) can be carried out by a solution polymerization method using a polymerization initiator if necessary.

Examples of the polymerization solvent used in the solution polymerization method include ethyl acetate, n-butyl acetate, isobutyl acetate, toluene, acetone, hexane, and methyl ethyl ketone. The polymerization solvent may be used singly or two or more kinds thereof may be used concurrently.

Examples of the polymerization initiator include an azo-based compound and an organic peroxide, and two or more kinds of polymerization initiators may be used concurrently. Examples of the azo-based compound include 2,2′-azobisisobutyronitrile, 2,2′-azobis(2-methylbutyronitrile), 1,1′-azobis(cyclohexane-1-carbonitrile), 2,2′-azobis(2,4-dimethylvaleronitrile), 2,2′-azobis(2,4-dimethyl-4-methoxyvaleronitrile), dimethyl 2,2′-azobis(2-methylpropionate), 4,4′-azobis(4-cyanovaleric acid), 2,2′-azobis(2-hydroxymethylpropionitrile), and 2,2′-azobis[2-(2-imidazolin-2-yl)propane].

Examples of the organic peroxide include benzoyl peroxide, t-butyl perbenzoate, cumene hydroperoxide, diisopropyl peroxydicarbonate, di-n-propyl peroxydicarbonate, di(2-ethoxyethyl) peroxydicarbonate, t-butyl peroxyneodecanoate, t-butyl peroxypivalate, (3,5,5-trimethylhexanoyl) peroxide, dipropionyl peroxide, and diacetyl peroxide.

Incidentally, the weight average molecular weight of the obtained polymer can be adjusted by blending a chain transfer agent such as 2-mercaptoethanol in the polymerization step.

Subsequently, the crosslinking agent (B), the ultraviolet absorbing (C), the infrared absorbing agent (D), and the dilution solvent are added to the obtained solution of the (meth)acrylic acid ester polymer (A) and mixing is thoroughly performed to obtain an adhesive composition P (coating solution) that is diluted with a solvent. Additives may be added, if necessary.

Incidentally, in a case where any of the respective components is a solid component or a component that undergoes deposition when mixed with other components in an undiluted state, the component may be singly dissolved in or diluted with a dilution solvent in advance and then mixed with the other components.

Examples of the dilution solvent include aliphatic hydrocarbons such as hexane, heptane, and cyclohexane; aromatic hydrocarbons such as toluene and xylene; halogenated hydrocarbons such as methylene chloride and ethylene chloride; alcohols such as methanol, ethanol, propanol, butanol, and 1-methoxy-2-propanol; ketones such as acetone, methyl ethyl ketone, 2-pentanone, isophorone, and cyclohexanone; esters such as ethyl acetate and butyl acetate; and cellosolve solvents such as ethyl cellosolve.

The concentration and viscosity of the prepared coating solution may be within ranges in which coating is possible, and may be appropriately selected depending on the situation. For example, dilution is performed so that the concentration of the adhesive composition P becomes 10% to 60% by mass. Incidentally, when the coating solution is obtained, the addition of a dilution solvent or the like is not a necessary condition, and a dilution solvent may not be added if the adhesive composition P has a viscosity or the like that allows coating. In this case, the adhesive composition P becomes a coating solution in which the polymerization solvent for the (meth)acrylic acid ester polymer (A) itself is used as a dilution solvent.

### (1.7. Production of Adhesive Agent)

The adhesive agent constituting the adhesive agent layer is preferably obtained by crosslinking the adhesive composition P described above. Crosslinking of the adhesive composition P can usually be carried out by a heat treatment. Incidentally, this heat treatment can also serve as a drying treatment when the dilution solvent and the like are volatilized from the coating film of the adhesive composition P that is applied to the desired object.

The heating temperature in the heat treatment is preferably 50° C. to 150° C., more preferably 70° C. to 120° C. In addition, the heating time is preferably 10 seconds to 10 minutes, more preferably 50 seconds to 2 minutes.

After the heat treatment, an aging period of about 1 to 2 weeks at room temperature (for example, 23° C., 50% RH) may be provided if necessary. In a case where aging is required, an adhesive agent having a crosslinked structure is obtained after the aging period has elapsed. In a case where aging is not required, an adhesive agent having a crosslinked structure is obtained after the heat treatment has been terminated.

### (1.8. Production of Window Film)

The method for producing the window film is not particularly limited, and the window film may be produced by a known method. For example, a coating liquid of the composition for hard coat layer formation described above is applied onto one main surface of a substrate, and dried. After drying, the composition for hard coat layer formation from which the solvent has evaporated is cured by being irradiated with energy rays such as ultraviolet rays or electron beams, thereby forming a hard coat layer on the substrate.

In the case of performing irradiation with ultraviolet rays, the radiation dose with respect to the composition for hard coat layer formation is preferably 10 to 1000 mW/cm² in illuminance and 10 to 1000 mJ/cm² in quantity of light, more preferably 50 to 500 mW/cm² in illuminance and 50 to 500 mJ/cm² in quantity of light. Meanwhile, electron beam irradiation can be carried out using an electron beam accelerator or the like, and the radiation dose of the electron beam is preferably about 10 to 1000 krad. As the ultraviolet irradiation device, a known device such as a high pressure mercury lamp, a xenon lamp, or a metal halide lamp can be used.

Subsequently, the coating liquid of the adhesive composition is applied onto the other main surface of the substrate, and the adhesive composition is crosslinked by performing a heat treatment to form a coating layer having a predetermined thickness. The release surface of a release sheet is superimposed on the formed coating layer. In a case where aging is required, the coating layer becomes an adhesive agent layer after a predetermined aging period has elapsed. In addition, in a case where aging is not required, the coating layer itself becomes an adhesive agent layer. A window film is thus obtained.

Other examples of the method for producing the window film include the following methods. In the same manner as that described above, a hard coat layer is formed on a substrate. Next, the coating liquid of the adhesive composition described above is applied to the release surface of a release sheet, and the adhesive composition is crosslinked by performing a heat treatment to form a coating layer, thereby obtaining a release sheet with coating layer.

The obtained release sheet with coating layer and the surface of the substrate on which the hard coat layer is not formed are bonded together so as to be in contact with each other. In a case where aging is required, the coating layer becomes an adhesive agent layer after a predetermined aging period has elapsed. In addition, in a case where aging is not required, the coating layer itself becomes an adhesive agent layer. A window film is thus obtained.

Examples of the method for applying the coating liquids of the adhesive composition P and composition for hard coat layer formation include a bar coating method, a knife coating method, a roll coating method, a blade coating method, a die coating method, and a gravure coating method.

Incidentally, in the present specification, in a case where it is stated that “X to Y” (X and Y are any numerals), this also includes the meaning of “preferably larger than X” or “preferably smaller than Y” together with the meaning of “X or more and Y or less” unless otherwise specified. In addition, in a case where it is stated that “X or more” (X is any numeral), this includes the meaning of “preferably larger than X” unless otherwise specified, and in a case where it is stated that “Y or less” (Y is any numeral), this also includes the meaning of “preferably smaller than Y” unless otherwise specified.

The embodiments of the present invention have been described above, but the present invention is not limited to the embodiments in any way, and may be modified in various aspects within the scope of the present invention.

### EXAMPLES

Hereinafter, the present invention will be described in more detail using Examples, but the present invention is not limited to these Examples.

### Example 1

### 1. Preparation of (Meth)Acrylic Acid Ester Polymer (A)

A (meth)acrylic acid ester polymer (A) was prepared by copolymerizing 72.5 parts by mass of n-butyl acrylate, 20 parts by mass of ethyl acrylate, 5 parts by mass of methyl methacrylate, 0.5 parts by mass of 2-hydroxyethyl acrylate, and 2 parts by mass of acrylic acid. The molecular weight of the obtained (meth)acrylic acid ester polymer (A) was measured by the method described below, and the weight average molecular weight (Mw) was 700000.

The weight average molecular weight (Mw) is a weight average molecular weight that is measured (GPC measurement) by gel permeation chromatography (GPC) under the following conditions and calculated in terms of standard polystyrene.

### (Measurement Conditions)

GPC measuring instrument: manufactured by Tosoh Corporation, HLC-8020
GPC columns (passed in the following order): manufactured by Tosoh Corporation
TSK guard column HXL-H
TSK gel GMHXL (×2)
TSK gel G2000HXL
   Measurement solvent: Tetrahydrofuran
   Measurement temperature: 40° C.

### 2. Preparation of Adhesive Composition

Mixed were 100 parts by mass (value calculated in terms of solids; the same applies hereinafter) of the (meth)acrylic acid ester polymer (A) obtained above, 0.25 parts by mass of aluminum trisacetylacetonate (B1) as a crosslinking agent (B), 0.15 parts by mass of N,N,N′,N′-tetraglycidyl-m-xylylenediamine (B2) as a crosslinking agent (B), 7 parts by mass of a triazine-based ultraviolet absorbing agent (manufactured by BASF, product name “Tinuvin 477”) (C1) as an ultraviolet absorbing agent (C), and 10 parts by mass of cesium-containing tungsten oxide (manufactured by Sumitomo Metal Mining Co., Ltd., product name “YMF-02AS”) (D1) as an infrared absorbing agent (D), and the mixture was thoroughly stirred and diluted with methyl ethyl ketone to obtain a coating solution of an adhesive composition having a solid concentration of 30% by mass.

### 3. Preparation of Composition for Hard Coat Layer Formation

50 parts by mass of dipentaerythritol pentaacrylate as an energy ray-curable resin (a), 50 parts by mass of dipentaerythritol hexaacrylate as an energy ray-curable resin, and 5.0 parts by mass of 2-methyl-[4-(methylthio)phenyl]-2-morpholino-1-propane as a photopolymerization initiator (b) were mixed, and the mixture was thoroughly stirred and diluted with propylene glycol monomethyl ether to obtain a coating solution of a composition for hard coat layer formation having a solid concentration of 30% by mass.

### 4. Production of Window Film

As a substrate, a polyethylene terephthalate (PET) film having a thickness of 38 μm was prepared. The prepared coating solution of the composition for hard coat layer formation was applied to one main surface of the PET film so as to have a thickness of 3 μm after drying by gravure coating. After coating, heating was performed at 70° C. for 1 minute to thoroughly remove the dilution solvent. Subsequently, the composition for hard coat layer formation was cured by being irradiated with ultraviolet rays in a nitrogen atmosphere using an ultraviolet irradiator (manufactured by GS Yuasa Corporation, product name “Nitrogen-purged small conveyor-type UV irradiator CSN2-40”) under the following conditions to form a hard coat layer (thickness: 3 μm), thereby obtaining a PET film with hard coat layer.

### [UV Irradiation Conditions]

Light source: High pressure mercury lamp
Lamp power: 1.4 kW
Conveyor speed: 1.2 m/min
Illuminance: 120 mW/cm²
Quantity of light: 240 mJ/cm²

Next, the prepared coating solution of the adhesive composition was applied to the release-treated surface of a release sheet (manufactured by LINTEC Corporation, product name “SP-PET381031”) in which one surface of a polyethylene terephthalate film was subjected to a release treatment with a silicone-based release agent so as to have a thickness after drying of 20 μm by die coating, heating was performed at 90° C. for 1 minute to thoroughly remove the dilution solvent, thereby forming an adhesive agent layer. The adhesive agent layer and the main surface of the PET film having a hard coat layer and on which a hard coat layer was not formed are bonded together so as to be in contact with each other, thereby obtaining a window film.

### Examples 2 to 9 and Comparative Example 1

Window films were produced in the same manner as in Example 1 except that the composition and molecular weight of the (meth)acrylic acid ester polymer (A), the kind and blended amount of the crosslinking agent (B), the blended amount of the infrared absorbing agent (D) constituting the adhesive agent layer, the thickness of the adhesive agent layer, the kind of the substrate layer, the kind and blended amount of the infrared absorbing agent (c), the kind and blended amount of the coloring agent constituting the hard coat layer, and the thickness of the hard coat layer were changed as presented in Table 1.

TABLE 1

| | Hard coat layer | | | | | | | | | | | | | |
|---|---|---|---|---|---|---|---|---|---|---|---|---|---|---|
| | | | | Infrared | | | | | | | | | | |
| | | Photopo- | | absorbing | | | | | | | | | | |
| | Curable | lymerization | | agent (c) | | | Coloring agent (d) | | | | α | β | Substrate layer | |
| | resin | initiator (b) | | | | % by | | | % by | Thickness | (% by | (% by | | Thickness |
| | (a) | | Parts | | Parts | mass | | Parts | mass | H | mass) × | mass) × | | T |
| | Composition | Kind | by mass | Kind | by mass | (α) | Kind | by mass | (β) | (μm) | H (μm) | H (μm) | Kind | (μm) |
| Example 1 | DPPA/ | b1 | 5 | — | — | — | — | — | — | 3 | — | — | A | 38 |
| Example 2 | DPHA = | | | — | — | — | — | — | — | 3 | — | — | | 38 |
| Example 3 | 50/50 | | | — | — | — | Black | 3 | 2.8 | 5 | — | 13.9 | | 38 |
| | | | | | | | pigment | | | | | | | |
| Example 4 | | | | — | — | — | — | — | — | 3 | — | — | | 38 |
| Example 5 | | | | — | — | — | — | — | — | 3 | — | — | B | 75 |
| Example 6 | | | | c1 | 75 | 41.7 | — | — | — | 5 | 208.3 | — | A | 38 |
| Example 7 | | | | c1 | 75 | 41.7 | — | — | — | 5 | 208.3 | — | A | 38 |
| Example 8 | | | | c1 | 30 | 22.2 | — | — | — | 3 | 66.7 | — | B | 75 |
| Example 9 | | | | c1 | 30 | 22.2 | — | — | — | 3 | 66.7 | — | A | 38 |
| Comparative | | | | — | — | — | — | — | — | 3 | — | — | A | 38 |
| Example 1 | | | | | | | | | | | | | | |

| | Adhesive agent layer | | | | | | | | | | | | | Total |
|---|---|---|---|---|---|---|---|---|---|---|---|---|---|---|
| | | | Cross- | | Ultraviolet | | | Infrared | | | | | | thick- |
| | | | linking | | absorbing | | | absorbing | | | | X | Y | ness |
| | (Meth)acrylic | | agent (B) | | agent (C) | | | agent (D) | | | Thick- | (% | (% | of |
| | acid ester | | | Parts | | Parts | % by | | Parts | % by | ness | by | by | window |
| | polymer (A) | | | by | | by | mass | | by | mass | Z | mass) × | mass) × | film |
| | Composition | Mw | Kind | mass | Kind | mass | (X) | Kind | mass | (Y) | (μm) | Z (μm) | Z (μm) | (μm) |
| Example 1 | BA/EA/MMA/ | 700000 | B1 | 0.25 | C1 | 7 | 6.0 | D1 | 10 | 8.5 | 20 | 119.3 | 170.4 | 61 |
| | HEA/AA = | | B2 | 0.15 | | | | | | | | | | |
| | 72.5/20/5/0.5/2 | | | | | | | | | | | | | |
| Example 2 | BA/EA/MMA/ | 700000 | B1 | 0.25 | | | 5.1 | D1 | 30 | 21.8 | 20 | 101.9 | 436.7 | 61 |
| | HEA/AA = | | B2 | 0.15 | | | | | | | | | | |
| | 72.5/20/5/0.5/2 | | | | | | | | | | | | | |
| Example 3 | BA/EA/MMA/ | 700000 | B1 | 0.25 | | | 5.1 | D1 | 30 | 21.8 | 20 | 101.9 | 436.7 | 63 |
| | HEA/AA = | | B2 | 0.15 | | | | | | | | | | |
| | 72.5/20/5/0.5/2 | | | | | | | | | | | | | |
| Example 4 | 2EHA/MMA/ | 700000 | B3 | 0.25 | | | 6.0 | D1 | 10 | 8.5 | 20 | 119.4 | 170.6 | 61 |
| | HEA = | | | | | | | | | | | | | |
| | 60/20/20 | | | | | | | | | | | | | |
| Example 5 | BA/EA/MMA/ | 700000 | B1 | 0.25 | | | 6.3 | D1 | 4 | 3.6 | 20 | 125.7 | 71.8 | 98 |
| | HEA/AA = | | B2 | 0.15 | | | | | | | | | | |
| | 72.5/20/5/0.5/2 | | | | | | | | | | | | | |
| Example 6 | BA/EA/MMA/ | 700000 | B1 | 0.25 | | | 6.5 | — | — | — | 20 | 130.4 | — | 63 |
| | HEA/AA = | | B2 | 0.15 | | | | | | | | | | |
| | 72.5/20/5/0.5/2 | | | | | | | | | | | | | |
| Example 7 | 2EHA/MA/ | 500000 | B1 | 0.5 | | | 6.5 | — | — | — | 10 | 65.1 | — | 53 |
| | HEMA/AA = | | | | | | | | | | | | | |
| | 58/30/2/10 | | | | | | | | | | | | | |
| Example 8 | BA/i-BA/Vac/ | 700000 | B4 | 0.35 | | | 6.5 | — | — | — | 20 | 130.4 | — | 98 |
| | HEMA = | | | | | | | | | | | | | |
| | 44/44/5/7 | | | | | | | | | | | | | |
| Example 9 | BA/i-BA/Vac/ | 700000 | B4 | 0.35 | | | 6.5 | — | — | — | 20 | 130.4 | — | 61 |
| | HEMA = | | | | | | | | | | | | | |
| | 44/44/5/7 | | | | | | | | | | | | | |
| Comparative | 2EHA/MMA/Vac/ | 700000 | B4 | 0.5 | | | 6.0 | D1 | 10 | 8.5 | 20 | 119.1 | 170.2 | 61 |
| Example 1 | 4HBA = | | | | | | | | | | | | | |
| | 70/10/18/2 | | | | | | | | | | | | | |

Details of the abbreviations and the like described in Table 1 are as follows.

### [Hard Coat Layer]

### (Curable Resin (a))

DPPA: Dipentaerythritol pentaacrylate
DPHA: Dipentaerythritol hexaacrylate

### (Photopolymerization Initiator (b))

b1: 2-Methyl-[4-(methylthio)phenyl]-2-morpholino-1-propane

### (Infrared Absorbing Agent (c))

c1: Cesium-containing tungsten oxide (manufactured by Sumitomo Metal Mining Co., Ltd., product name “YMF-02AS”)

### (Coloring Agent)

Black pigment: Carbon black-based pigment having physical properties presented in Table 3

### [Substrate Layer]

A: Polyethylene terephthalate (PET) film with thickness of 38 μm
B: Laminated film including polyethylene terephthalate (PET) with thickness of 75 μm

### [Adhesive Agent Layer]

### ((Meth)Acrylic Acid Ester Polymer (A))

BA: n-Butyl acrylate
i-BA: Isobutyl acrylate
EA: Ethyl acrylate
MMA: Methyl methacrylate
HEA: 2-Hydroxyethyl acrylate
HEMA: 2-Hydroxyethyl methacrylate
AA: Acrylic acid
MA: Methyl acrylate
2EHA: 2-Ethylhexyl acrylate
Vac: Vinyl acetate
4HBA: 4-Hydroxybutyl acrylate

### (Crosslinking Agent (B))

B1: Aluminum trisacetylacetonate
B2: N,N,N′,N′-Tetraglycidyl-m-xylylenediamine
B3: Isocyanate-based crosslinking agent (manufactured by Mitsui Chemicals, Inc., product name “TAKENATE D-101E”)
B4: Isocyanate-based crosslinking agent (manufactured by Mitsui Chemicals, Inc., product name “TAKENATE D-165N”)

### (Ultraviolet Absorbing Agent (C))

C1: Triazine-based ultraviolet absorbing agent (manufactured by BASF, product name “Tinuvin 477”)

### (Infrared Absorbing Agent (D))

D1: Cesium-containing tungsten oxide (manufactured by Sumitomo Metal Mining Co., Ltd., product name “YMF-02AS”)

The window films produced in Examples and Comparative Examples were used to carry out the following evaluations.

### (Creep Compliance of Adhesive Agent)

A plurality of adhesive agent layers of the window film produced in each of Examples and Comparative Examples were laminated to form a laminate having a thickness of 800 μm (0.8 mm). A cylindrical body having a diameter of 8 mm (height of 800 μm) was punched out from the obtained laminate of the adhesive agent layer to prepare a sample for creep compliance measurement.

A shear stress of 3000 Pa was continuously applied to the sample for measurement at a measurement temperature of 23° C. using a viscoelasticity measuring instrument (manufactured by Anton Paar GmbH, MCR301) to measure the creep compliance (1/MPa). The measurement points were 1000 points. The creep compliance after 1200 seconds was calculated from the measurement results. The results are presented in Table 2.

### (Storage Modulus G′ and Loss Tangent (Tan δ) of Adhesive Agent)

A plurality of adhesive agent layers of the window film produced in each of Examples and Comparative Examples were laminated to form a laminate having a thickness of 800 μm (0.8 mm). A cylindrical body having a diameter of 8 mm (height of 800 km) was punched out from the obtained laminate of the adhesive agent layer to prepare a sample for storage modulus and loss tangent measurement.

The storage modulus and loss modulus of the sample for measurement were measured by the torsional shear method under conditions of a measurement temperature range of −20° C. to 140° C., a measurement frequency of 1 Hz, and a temperature increase rate of 4° C./min using a viscoelasticity measuring instrument (manufactured by Anton Paar GmbH, MCR301) in conformity with JIS K7244-1. The storage modulus and loss tangent at each of 23° C., 40° C., and 80° C. were calculated from the measurement results. The results are presented in Table 2.

### (Evaluation of Gel Fraction and Sol Fraction of Adhesive Agent)

The window films produced in Examples and Comparative Examples were cut to a size of 50 mm×50 mm, the adhesive agent layer thereof was wrapped in a polyester mesh (product name: Tetoron Mesh #200), and the mass was measured using a precision balance. The mass of the adhesive agent alone was calculated by subtracting the mass of the mesh alone from the weighed value. The mass at this time was designated as M1.

Next, the adhesive agent wrapped in a polyester mesh was immersed in ethyl acetate at room temperature (23° C.) for 24 hours. Thereafter, the mesh was taken out and air-dried in an environment of a temperature of 23° C. and a relative humidity of 50% for 24 hours, and further dried in an oven at 80° C. for 12 hours. After drying, the mass was measured using a precision balance. The mass of the adhesive agent alone was calculated by subtracting the mass of the mesh alone from the weighed value. The mass at this time was designated as M2. Using the obtained M1 and M2, the gel fraction and the sol fraction were calculated from the following equations. The results are presented in Table 2.

$$Gel fraction ( \% ) = ( M 2 / M 1 ) \times 100 \\ Sol fraction ( \% ) = 100 - gel fraction$$

### (Adhesive Force of Window Film)

The adhesive force of the window films produced in Examples and Comparative Examples was measured as follows. The obtained window film was cut to a width of 25 mm and a length of 100 mm. The release sheet was peeled off from the window film in an environment of 23° C. and 50% RH, and the exposed adhesive agent layer was attached to a float glass plate having a thickness of 3 mm. At this time, the window film was attached by being pressurized back and forth once with a 2 kg roller. After attachment, the window film was left for 24 hours under conditions of 23° C. and 50% RH. After leaving, the adhesive force (N/25 mm) of the window film was measured using a tensile tester (TENSILON manufactured by ORIENTEC CO., LTD.) under conditions of a peel speed of 0.3 m/min and a peel angle of 180°. Incidentally, the conditions other than those described here were set to conform to those in JIS Z0237:2009, and the measurement was performed. The results are presented in Table 2.

### (Optical Properties of Window Film)

The visible light transmittance, ultraviolet transmittance, near-infrared transmittance, and haze value of the window film were measured as follows. The release sheet was peeled off from each of the window films obtained in Examples and Comparative Examples, and the exposed adhesive agent layer was attached to a float glass plate having a thickness of 3 mm. In conformity with JIS 53107, the window film was irradiated with light in the wavelength range of 300 to 2500 nm using a UV-Vis-NIR spectrophotometer (UV-3600 manufactured by SHIMADZU CORPORATION) to measure the light transmittance of the window film. From the measurement results, the light transmittance (ultraviolet transmittance) in the wavelength range of 300 to 380 nm, the light transmittance (near-infrared transmittance) in the wavelength range of 780 to 2500 nm, and the light transmittance (visible light transmittance) in the wavelength range of 380 to 780 nm were calculated, respectively. In addition, the haze value of the window film was measured in conformity with JIS K7136:2000 using a haze meter (manufactured by NIPPON DENSHOKU INDUSTRIES CO., LTD., NDH-5000). The results are presented in Table 2.

### (Evaluation of Glue Slippage Resistance)

The glue slippage resistance of the window film was evaluated as follows. Using a sprayer, a 10% by mass aqueous solution of an anionic surfactant was sprayed onto the entire glass surface. Thereafter, the window films produced in Examples and Comparative Examples were disposed on the glass surface, and the window films were pasted with water by hand while being pressed using a squeegee. Thereafter, the window film was shifted 1 cm parallel to the glass surface by hand to simulate positioning during installation. Thereafter, the interface between the adhesive agent layer and the glass surface was visually observed, and the glue slippage was evaluated according to the following criteria. The results are presented in Table 2.

A: No cloudiness occurred and the window film was at a level that was favorable for practical use.

B: Slight cloudiness occurred but the window film was at a level that was acceptable for practical use.

F: Significant cloudiness occurred and the window film was at a level that was problematic for practical use.

### (Scratch Resistance of Hard Coat Layer)

The scratch resistance of the hard coat layer of the window film was evaluated as follows. The release sheet was peeled off from each of the window films obtained in Examples and Comparative Examples, and the exposed adhesive agent layer was attached to a float glass plate having a thickness of 3 mm. A #0000 steel wool was placed on the hard coat layer of the window film, and the steel wool was moved back and forth over the hard coat layer 10 times while being pressed at 250 g/cm². Thereafter, the place on the hard coat layer where the steel wool had been moved was visually observed, and scratches were evaluated according to the following criteria. The results are presented in Table 2.
A: No scratches were found
B: 1 to 5 scratches were found
F: More than 5 scratches were found all over the surface

TABLE 2

| | Physical properties of window film | | | | Physical properties of adhesive agent layer | | | | | | | | Evaluation | |
|---|---|---|---|---|---|---|---|---|---|---|---|---|---|---|
| | Ultra- | Near- | | Visible | | | | | Loss | | | | Scratch | Glue |
| | violet | infrared | | light | adhesive | | | | tangent | Creep | Gel | Sol | resis- | slip- |
| | transmit- | transmit- | | transmit- | force | | | | tanδ | compli- | frac- | frac- | tance | page |
| | tance | tance | Haze | tance | (N/25 | Storage modulus (MPa) | | | at | ance | tion | tion | of hard | resis- |
| | (%) | (%) | (%) | (%) | mm) | 23° C. | 40° C. | 80° C. | 23° C. | (1/MPa) | (%) | (%) | coat | tance |
| Example 1 | ≤1 | 13.6 | 2.0 | 76.5 | 9.2 | 0.13 | 0.09 | 0.05 | 0.35 | 23.9 | 77 | 23 | A | A |
| Example 2 | ≤1 | 0.6 | 2.2 | 57.8 | 10.5 | 0.17 | 0.11 | 0.06 | 0.39 | 22.0 | 72 | 28 | A | A |
| Example 3 | ≤1 | 0.4 | 2.0 | 38.4 | 10.3 | 0.17 | 0.11 | 0.06 | 0.39 | 22.0 | 72 | 28 | A | A |
| Example 4 | ≤1 | 13.5 | 1.9 | 75.8 | 20.1 | 0.14 | 0.07 | 0.03 | 0.67 | 77.5 | 71 | 29 | A | B |
| Example 5 | ≤1 | 27.8 | 1.4 | 83.5 | 8.8 | 0.11 | 0.08 | 0.05 | 0.31 | 25.3 | 78 | 22 | A | A |
| Example 6 | ≤1 | 6.7 | 1.0 | 72.6 | 8.0 | 0.10 | 0.08 | 0.05 | 0.29 | 29.5 | 80 | 20 | B | A |
| Example 7 | ≤1 | 6.5 | 1.1 | 72 | 20.5 | 0.23 | 0.10 | 0.04 | 0.87 | 54.2 | 63 | 37 | B | A |
| Example 8 | ≤1 | 26.6 | 0.5 | 82.0 | 17.3 | 0.09 | 0.05 | 0.03 | 0.50 | 65.1 | 61 | 39 | B | A |
| Example 9 | ≤1 | 35.6 | 0.4 | 85.1 | 14.0 | 0.09 | 0.05 | 0.03 | 0.50 | 65.1 | 61 | 39 | B | A |
| Comparative | ≤1 | 13.8 | 2.0 | 75.2 | 15.2 | 0.06 | 0.04 | 0.02 | 0.50 | 230.0 | 66 | 34 | A | F |
| Example 1 | | | | | | | | | | | | | | |

TABLE 3

| Kind | Haze | Haze | Difference | | Standard |
|---|---|---|---|---|---|
| of | value at | value at | in haze | Average | deviation |
| coloring | 380 nm | 780 nm | value | haze | of haze |
| agent | (%) | (%) | (points) | (%) | value |
| Black | 10.1 | 2.3 | 7.8 | 6.2 | 1.49 |
| pigment | | | | | |

From Table 2, it has been found that the window films of Examples 1 to 9 are excellent in glue slippage resistance and further have high infrared absorbing ability.

### INDUSTRIAL APPLICABILITY

The window film of the present invention can be suitably used, for example, by being attached to windows of moving objects such as motor vehicles, windows of buildings, and the like. In addition, the window film of the present invention can be applied by being attached to glass other than window glass and glass substitute materials (for example, plastic). Furthermore, the window film of the present invention can be applied by being attached to windows, mirrors, and the like that are formed of glass or glass substitute materials, have a light control function, and a function of displaying an image or letter that is different from the scenery visible through the windows on the windows. Such windows, mirrors, and the like may have functions of a touch panel and the like.

### EXPLANATIONS OF LETTERS OR NUMERALS

1 WINDOW FILM
10 SUBSTRATE
11 ADHESIVE AGENT LAYER
12 HARD COAT LAYER

1. A window film, comprising:
a substrate; and
an adhesive agent layer disposed on one main surface of the substrate,
wherein a creep compliance of the adhesive agent layer after 1200 seconds of continuous application of a shear stress of 3000 Pa at 23° C. is 200 (1/MPa) or less.

2. The window film according to claim 1, wherein the window film has infrared absorbing property.

3. The window film according to claim 2, wherein the adhesive agent layer contains an infrared absorbing agent.

4. The window film according to claim 1, wherein the adhesive agent layer contains an ultraviolet absorbing agent.

5. The window film according to claim 1, further comprising a hard coat layer disposed on the other main surface of the substrate.

6. The window film according to claim 5, wherein the window film has infrared absorbing property and the hard coat layer contains an infrared absorbing agent.

7. The window film according to claim 5, wherein the hard coat layer contains a coloring agent.
